(19) United States
(12) Patent Application Publication
(10) Pub. No.: US 2022/0126762 A1
(43) Pub. Date: Apr. 28, 2022

(54) Cell Caddy

(71) Applicant: Perry Allen Stiles, Durant, OK (US)

(72) Inventor: Perry Allen Stiles, Durant, OK (US)

(21) Appl. No.: 17/079,442

(22) Filed: Oct. 24, 2020

(51) Int. Cl. B60R 11/02; H04M 1/725; H04B 1/3888

(52) U.S. Cl. CPC B60R 11/0241; B60R 2011/001; H04B 1/3888; H04M 1/725

(57) ABSTRACT

The present invention, or “Cell Caddy” is designed for use on a golf cart in which the device securely holds an electronic device (Cell Phone) in addition to golf tees. The Cell Caddy will securely hold all sizes of cell phones and all styles and sizes of golf tees without any adjustments, or moving parts on the Cell Caddy including the most popular golf tee, the “Martini Tee,” which no other device is designed to hold. It is specifically designed to use the steering wheel clamp (clip) that is already permanently attached to all golf cart steering wheels. The Cell Caddy also has a “Living Hinge” just below the steering wheel clamp, thus giving the Cell Caddy the ability to swing upward and away from the scorecard that also uses the steering wheel clamp. With this design the Cell Caddy never has to be removed from the steering wheel clamp in order to gain access to the scorecard. The cell phone is in easy reach and does not have to be removed from the Cell Caddy for use.

### BACKGROUND

There are no current solutions or devices that can securely hold a cell phone on a Golf Cart in which the user can conveniently use the cell phone without first having to remove the cell phone from the device. There is no current solution or device that can hold all size golf tees including the most popular Martini Tee in easy reach in one location alongside a cell phone.

Golf carts include open compartments in which the electronic devices can slide around and break. Currently there are a number of solutions for accessory holders for holding personal electronics and/or other articles in golf carts. However, none of them can be placed in a convenient location for use by the operator and are flawed in other areas.

Accessory holders used in golf carts include Permanent/clamp-type mounts, Suction cup mounts and Cup holder mounts. Permanent/clamp-type mounts use screws and/or clamps to attach to some part of the golf cart structure like the struts holding the windshield. Suction cup mounts use suction cups to attach accessory holders to the windshield. Cup holder mounts insert into and engage the inner surface of beverage cup holders. None of these solutions allow for easy cell phone use, nor do they hold golf tees.

Permanent/clamp-type mounts are more suited for permanent attachment. Many golfers rent carts and would have to attach and remove this type mount, which is not convenient and may, or may not damage the rented cart. Mounts that attach to the windshield strut, can impede adjustment of a golf cart windshield. Permanent/clamp-type mounts can be bulky, making them difficult to store in a golf bag along with the other equipment that a golfer needs to store. Electronic devices using these types of mounts generally must be removed from the device for use. These types of devices are also not made to hold golf tees.

Suction cup mounts are adversely influenced by temperature and humidity fluctuations. The dynamic motion of a golf cart due to the poor suspension inherent in golf carts may also result in a bending moment applied to a Suction cup by the weight of the accessory device. Resulting in the release of the mount from the windshield and possible damage to the electronic device. Aging and repeated use of a Suction cup mount may also result in reduced reliability of the suction produced, resulting in the release of the device and potential damage to an attached electronic device. A Suction cup holder mount is also bulky, making it difficult to store in a golf bag along with the other equipment that the golfer needs in a golf bag. Electronic devices using these types of mounts generally must be removed from the device for use due to the distance between the user and the golf cart windshield. These types of devices are also not made to hold golf tees.

Cup holder mounts take up one of the two beverage holders in a golf cart, eliminating the beverage holder for the driver, or the passenger. This device may also impede access to the other beverage holder that is not being used by the device. A cup holder mount is also bulky, making it difficult to store in a golf bag along with the other equipment that the golfer needs in a golf bag. Electronic devices using these types of mounts generally must be removed from the device for use. These types of devices are also not made to hold golf tees.

In addition, any solution that uses rubber or plastic under stress and/or pressure will eventually fail in outdoor conditions. The Cell Caddy avoids any such stress or pressures that might cause the device to fail regardless of weather conditions. In fact, by design it is impossible for the Cell Caddy to ever fail regardless of outdoor weather conditions. Thus, no other solution can provide the same level of electronic device protection and security as the Cell Caddy and provide such easy access.

In conclusion, none of the above-mentioned solutions allow for easy cell phone accessibility and use due to their location and their distance from the operator. The operator must reach to remove the cell phone from the apparatus in order to access the cell phone or electronic device for use.

The Cell Caddy provides the operator with a close proximity to their electronic device. Thus, allowing for easy access and not having to remove the electronic device from the mount device in order see and/or use is it.

Finally, the Cell Caddy also provides the operator easy access to any size golf tee including the most popular tee, “The Martini Tee”. There is no other device on the market that is designed to hold the “Martini Tee”. There is no other device on the market that is designed to hold any size golf tee.

### SUMMARY OF THE INVENTION

This invention provides reliable and secure phone security and the convenience for golfers to easily use and have access to their cell phone and cell phone apps for keeping score, golf course GPS apps, listening to music etc. . . . . In addition, it provides a convenient way to store and easily access any size golf tee.

Some differences and benefits of the Cell Caddy opposed to any other current solution or device on the market today are as follows;

1. Holds all sizes of Cell Phones with no moving parts with easy access for use.

2. Holds all sizes of Tees including the “Martini Tee” with easy access for use.

3. “Living Hinge” providing a 90-degree fold for Scorecard easy access.

The Cell Caddy is one solid piece with no moving parts or adjustable components. It is specifically designed to be used on a golf cart using the scorecard clamp that is already permanently attached to all golf cart steering wheels. The cell phone sits in the bed of the Cell Caddy using a small round Velcro dot. On each side of the Cell Caddy bed is a uniquely designed golf tee bed that will hold all sizes of golf tees with no moving parts.

The Cell Caddy will securely hold all sizes of cell phones. Regardless of whether they are in a protective phone case or not. There are no size adjustments, or moving parts on the Cell Caddy to adjust for various cell phone size configurations because none are needed by design. In addition, it will hold 2 golf tees of any size next to your cell phone for convenience.

The Cell Caddy is unique when compared with other known devices and solutions, because it has no moving parts that can fail over time and no suction devices that will initially and/or ultimately fail on a golf cart. Windshield suction cup mounts have a tendency to lose suction and not be secure and/or reliable for outdoor use on a golf cart due to weather conditions and the lack of suspension on a golf cart. Also, whether it be suction devices that use the windshield, clamp-type mounts using the windshield/roof support bar, or the possible cup holder on the golf cart dash. All of these locations are too far away from the golf cart operator for them to easily reach and effectively use their cell phone, so the cell phone must be removed from the current solutions to actually use the cell phone.

With that being said, the Cell Caddy conveniently holds the cell phone close to the operator that is in easy reach, so device removal is not necessary for device use. It is also more easily stored during transportation than any other current solution.

The simplicity in design yet without sacrificing versatility, also provides for zero chance of failure unlike other products on the market. In addition, the Cell Caddy also holds any size golf tee in an easily accessible location next to the cell phone, or electronic device. There is no other product on the market that holds these two needed items together in one place. The disclosed device is unique in that it is structurally different from other known devices or solutions. More specifically, the device is unique due to the fact that it is a one-piece device with no movable parts or adjustments required to securely hold a cell phone regardless of phone size. This device is also unique in the fact that it will hold any size golf tee, but it will also hold the large Martini Tee and there is no other solution or product on the market that can make this claim.

### DETAILED DESCRIPTION OF THE INVENTION

This device is made up of the following components;

A Flat Tab that slides under the steering wheel clamp that has a Ridge on the top of the Flat Tab. The Ridge hooks on to the steering wheel clamp and prevents the Cell Caddy from sliding downward out of the clamp. Two Posts attached to each side of the Flat Tab that is placed on each outside edge of the steering wheel clamp for Flat Tab stability. The Posts prevents the Flat Tab from moving to the left or to the right and keeps it straight within the scorecard clamp. This keeps the Ridge properly aligned within the scorecard clamp preventing a possible Flat Tab connection failure to the scorecard clamp. The Flat Tab is attached to the top of the Cell Caddy bed frame with a Living Hinge. The Living Hinge allows the Cell Caddy to fold up and away from the steering wheel and golf scorecard at a 90-degree angle giving the user access to the scorecard.

The Cell Caddy Frame is attached to the Flat Tab with a Living Hinge. The rectangular Frame consisting of four walls surrounds the rectangular Bed. The bottom wall of the Frame has a cut out to accommodate for the charging port on the electronic device. The Bed uses Velcro to attach the cell phone or electronic device to the Bed.

Golf Tee Holders are attached to each side of the Frame. These two holders each have a tee bed and each use 6 vertical tabs strategically sized and placed to accommodate for all styles and sizes of golf tees.

No other devices use any of the above-mentioned components, or can hold a cell phone and/or golf tees using the steering wheel clamp on a golf cart.

Graphic designs, logos and/or lettering may be placed in the Cell Caddy Bed, or the backside of the Bed. The device may be made out of, but not limited to; plastic, rubberized material, wood, metal and/or fiberglass, or any combination. Injection molding and/or other types manufacturing may be used depending on the types of material used for production.

### BRIEF DESCRIPTION OF THE DRAWINGS

FIG. 1—Shows the Front view of the Cell Caddy.

FIG. 2—Shows the Back view of the Cell Caddy.

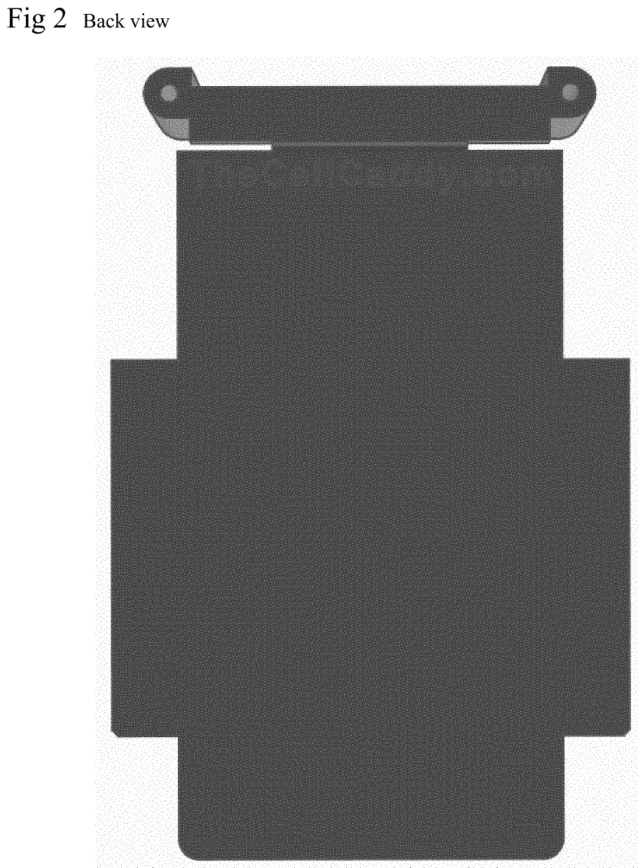

FIG. 3—Shows the Left and Right-side views of the Cell Caddy.

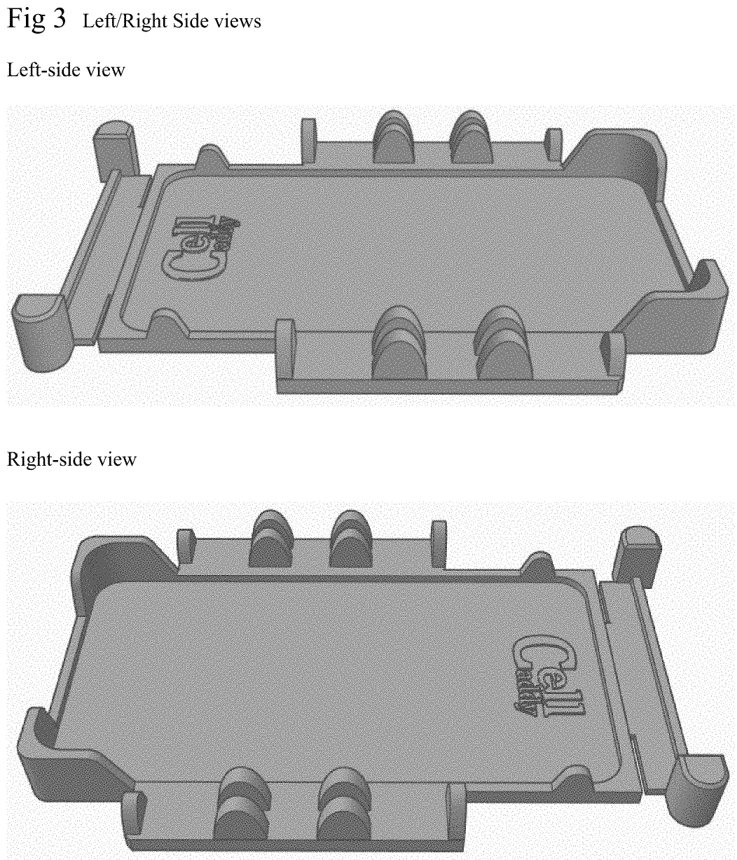

FIG. 4—Shows the Front Bottom view of the Cell Caddy.

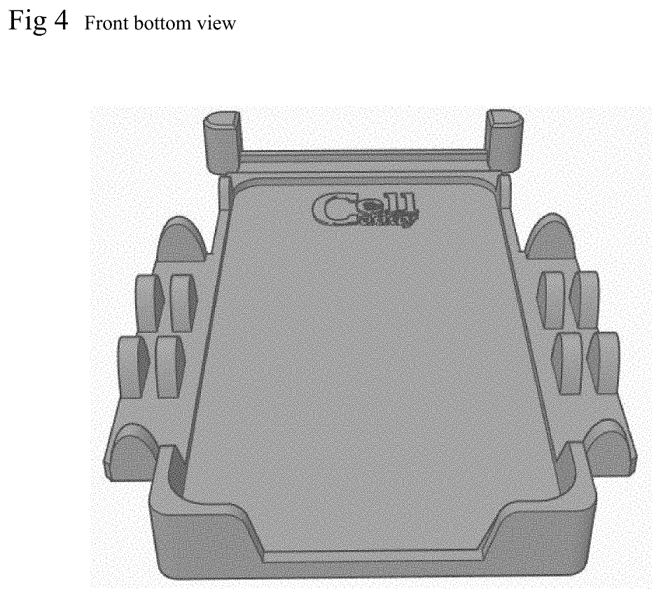

FIG. 5—Shows the Front Top view of the Cell Caddy.

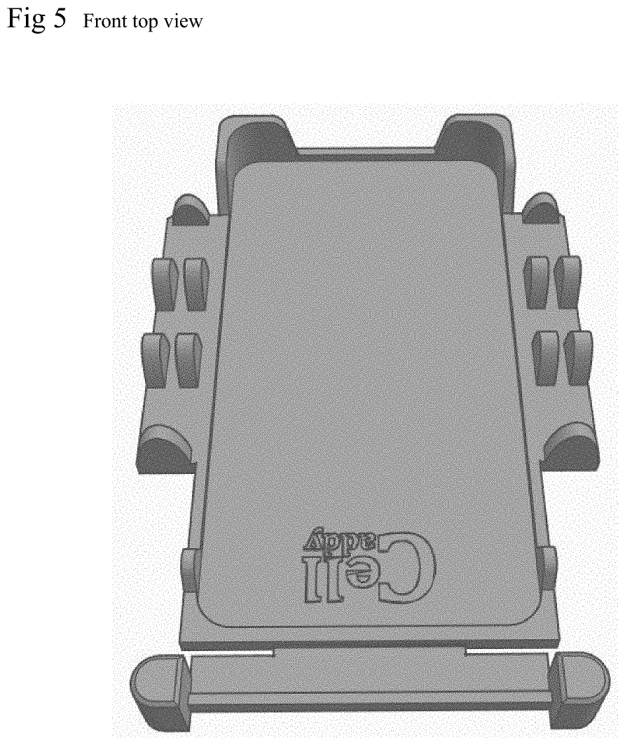

FIG. 6—Shows a view of the Cell Caddy attached to a golf cart steering wheel.

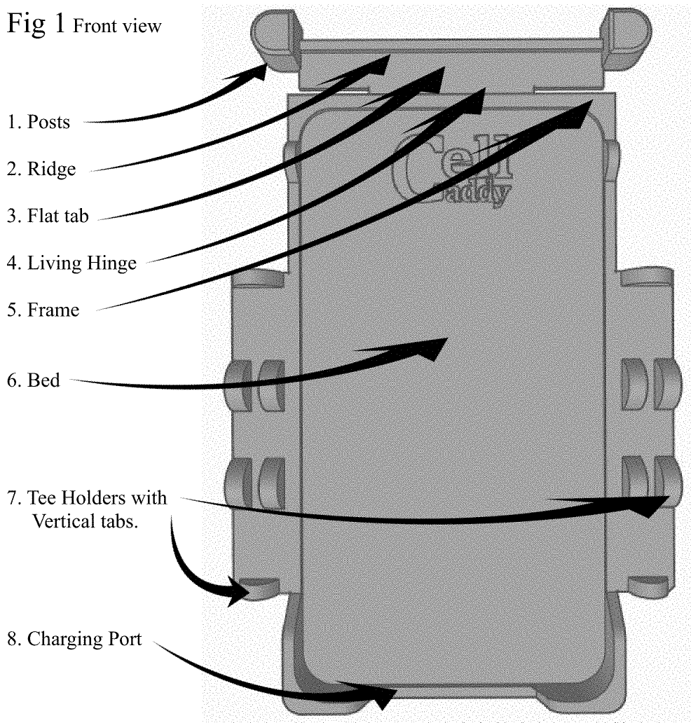

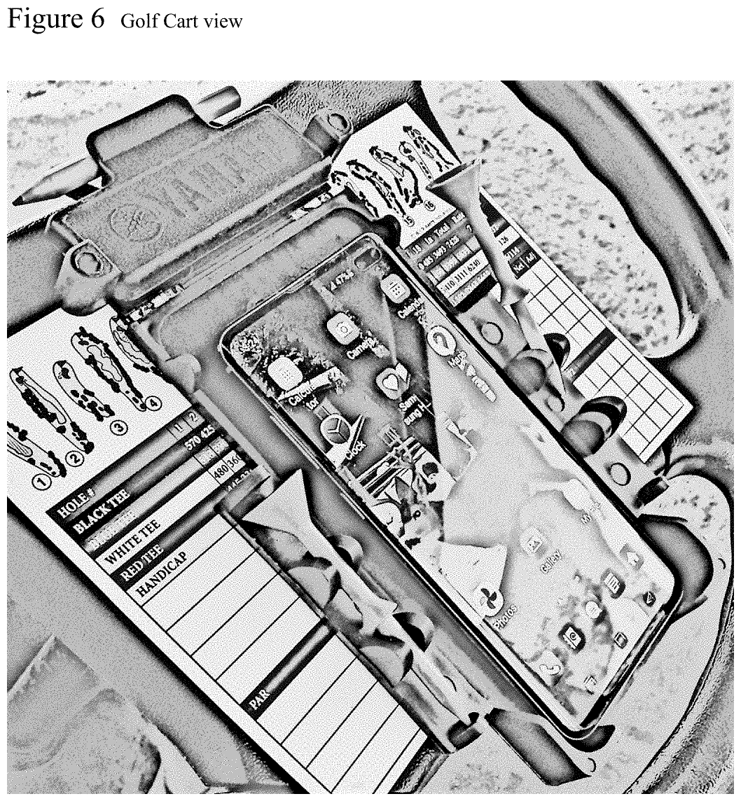

### DETAILED DESCRIPTION OF FIG. 1

FIG. 1 Shows the front view of the Cell Caddy.

#1. illustrates the two Posts that fits on the outside of the steering wheel clamp for stability.

#2. illustrates the Ridge that the steering wheel clamp hooks on to that prevents the Cell Caddy from sliding out of the clamp.

#3. illustrates the Flat tab that slides under the steering wheel clamp.

#4. illustrates the Living Hinge that allows the Cell Caddy to fold upward and away from the scorecard.

#5. illustrates the rectangular Frame that surrounds the Cell Caddy bed.

#6. Illustrates the Bed that uses Velcro to hold the electronic device.

#7. illustrates the two Golf Tee Holders with Vertical Tabs.

#8. Illustrates cut-out for charging port.

1. Connects to a golf cart steering wheel clamp using a Flat Tab with a Ridge and will fold upward away from the steering wheel using a Living Hinge.

2. Will hold golf tees using Vertical Tabs.

3. Will hold both a cell phone and golf tees on a golf cart steering wheel.
